(19) United States
(12) Patent Application Publication
(10) Pub. No.: US 2024/0359835 A1
(43) Pub. Date: Oct. 31, 2024

(54) UAV DOCKING SYSTEM FOR AUTONOMOUS LANDING AND DOCKING

(71) Applicant: SVARMI EHF., Kopavogur (IS)

(72) Inventor: Tryggvi STEFANSSON, Hafnarfjordur (IS)

(21) Appl. No.: 18/685,300

(22) PCT Filed: Aug. 24, 2022
(86) PCT No.: PCT/IS2022/050006

§ 371 Date: Feb. 21, 2024

(30) Foreign Application Priority Data
Aug. 24, 2021 (IS) 050343

(51) Int. Cl. B64U 70/99; B60L 53/16; B64U 80/25

(52) U.S. Cl. CPC B64U 70/99; B60L 53/16; B64U 80/25; B60L 2200/10

(57) ABSTRACT

A landing and docking system for an unmanned aerial vehicle (UAV), the system comprises two main parts, a docking unit configured to be attached to a UAV and a mating ground base platform. The docking unit has clamping arms that can swing outwardly by hinges that have a spring function, and a downwardly extending cone portion shaped to mate with a corresponding drogue shaped receptacle in the ground platform. The clamping arms comprise inwardly extending hook parts to hold the docking unit in place in the ground base platform. The system preferably comprises a sensor array in the cone, that comprises at least one but preferably at least two or more sensors such as optical lenses and/or other sensors. The system with sensor array thus provides a rugged and sturdy alternative to conventional camera carrying UAVs with gimbal mounted camera.

### FIELD OF INVENTION

The present invention is within the field of unmanned aerial vehicles (UAV) and specifically relates to a landing and docking system that comprises a docking unit, configured to be attached to the UAV and a mating ground platform, and methods to facilitate automatic landing, docking and take off by a UAV using the system. The invention also introduces a new way for drones to harvest wind energy while docked to charge batteries.

### TECHNICAL BACKGROUND

Unmanned aerial vehicles (UAV) are used in various applications today in particular for aerial photography, surveillance and monitoring of various kind. Such UAVs can be operated at least partially autonomously. WO2016015301A1 and EP3222530B1 describe on-the-ground landing platforms and positioning mechanisms for UAVs to automatically land and dock onto docking stations on such platforms.

Stefansson in “A UAV mechanism for autonomous landing and transportation of cargo” (Stefansson Tryggvi, M.Sc. thesis MMK 2014:28 MKN 118, KTH, Stockholm, 2014) describes some different platforms for landing and docking a UAV, including UAVs with a downwardly protruding cone portion that mates with and docks in a corresponding drogue shaped base. A few different variants are suggested for anchoring the UAV to the base.

### SUMMARY OF INVENTION

The present invention relates to new and modified systems and methods for landing and docking an unmanned aerial vehicle (UAV) on the ground. The system comprises two main parts, a docking unit configured to be attached to a UAV and a mating ground base platform. The docking unit is equipped with clamping arms that can swing outwardly by hinges that have a spring function. The docking unit comprises a downwardly extending cone portion shaped to mate with a corresponding drogue shaped receptacle in the ground platform.

The system preferably comprises a sensor array (for example camera sensors and/or other sensor types that may be either or both active and passive sensors) comprised in the cone portion, that comprises at least one but preferably at least two and more preferably at least 4 or 5 camera sensors (optical lenses) and/or other active/passive sensors. The sensor array can also be referred to as a camera array. The lenses and/or sensors can advantageously be situated in suitable holes/windows in the cone. The system with the sensor array thus provides a rugged and sturdy alternative to conventional sensor-carrying UAVs with gimbal mounted sensors.

In one aspect the invention relates to landing and docking system for an unmanned aerial vehicle (UAV) that comprises
a) a ground base platform comprising a drogue receptacle, an upper rim above the receptacle, a tapered collar extending outwardly and downwardly from the upper rim to an inwardly extending edge,
b) a docking unit, configured to be attached to the UAV, the docking unit comprising
   a downwardly extending central cone portion shaped to mate with the drogue shaped receptacle of the ground base platform,
   at least two and preferably three clamping arms joined to the landing platform above and radially outwardly of the central conical portion, the clamping arms being joined each with a hinge or joint mechanism on the upper part of the clamping arm with a spring function, each clamping arm comprising an inwardly extending foot or hook part, the spring function providing a spring force pulling the foot or hook part of each arm inwardly, said clamping arms configured such that as the docking unit docks with the ground base platform the arms are initially pushed outwardly by the tapered collar of the ground base platform, and as the central conical portion is settled in the drogue receptacle the foot or hook parts slide under the inwardly extending edge so as to hold the docking unit in place in the ground base platform.

Thus, the spring function of the clamping arms provides a spring force that creates a default force pulling the arms inwardly towards the central axis of the cone of the docking unit. The hinge or joint mechanism is arranged such that the arms do not move too far inwardly in a non-docked position (e.g., a flying position) so that when an UAV lands and positions its cone in the drogue, as the lower ends of the arms touch the rim or tapered collar of the ground base platform, the arms are pushed outwardly by the tapered collar of the base as the cone is lowered into the drogue. When the cone has fully settled in the drogue the foot or hook parts of the arms latch themselves underneath the inwardly extending edge of the base and thereby lock the docking unit in place in the base.

Another aspect of the invention provides a UAV system that comprises a UAV and an engaged docking unit as described herein.

A further aspect of the invention provides a kit comprising a landing and docking system as described herein, and a UAV that can engage with the docking unit.

It is an advantage of the present landing and docking system that the landing function of the clamping arms can preferably operate fully automatically by means of the mechanical spring function, without any control, e.g., motorized movement, electronic input or the like. Thus, even in case of an electric malfunction, as long as the UAV steers into the base and lands substantially in the center of the drogue, the arms will latch onto the base.

In a useful embodiment the UAV is configured such that when docking the UAV in wind, the UAV can be tilted into the wind to compensate the external force the wind generates on the UAV. Since each clamping arm can move individually the clamping arm facing the wind will lock first in place before the UAV is fully docked greatly assisting landing/docking in wind. Once the first clamping arm has locked the UAV to the drogue, the wind pushes the UAV into the drogue and therefore no further forces are required to successfully dock except the wind and gravity.

The cone of the docking unit provides several advantages. Firstly, it forms part of a practical landing system, where the cone end does not need to enter exactly in the center of the drogue of the platform, as the cone will simply glide into and be guided by the surface of the mating drogue into a final seated docking position. Secondly, the cone provides an excellent enclosure for a sensor array (camera array), where holes or windows for lenses or similar component of other sensors can be placed in any direction, both radially from the cone as well as downwardly. Thirdly, the cone provides space for placing a battery and the cone and mating drogue provide excellent contact surfaces for surface-to-surface charging from an electrical charger in the ground base platform. Furthermore, the precise landing resulting from docking the cone into the drogue creates an ideal geometry for wirelessly charging the batteries onboard the UAV with high efficiency, for example when compared to wireless charging between two flat surfaces. Thus, in some embodiments the docking unit comprises means for wireless charging of batteries in the docking station or UAV, through contact with corresponding charging surfaces for wireless charging in the drogue of the landing platform.

The landing and docking system preferably is also equipped with a mechanism for unlocking the clamping arms from a locked docking position. In one embodiment such mechanism comprises an electrically controlled mechanism, for example, this can comprise one or more electrical motor that drive members (e.g., pistons) to extend radially or rotate to create a radially outwardly extension, such that the members push outwardly the locking arms. The unlocking mechanism can in some embodiments comprise other type of actuators, such as hydraulic or pneumatic actuators, which may be electronically controlled.

In another embodiment the arms are unlocked from the drogue by spinning the motors that rotate in the same direction faster than the other motors spinning in the opposite direction, as this will cause the drone to rotate (yaw). By doing this fast enough the arms will be pulled out due to the centrifugal forces (F=mω²r where m is the mass of the object, w is the angular velocity and r is the distance from the origin of a frame of reference rotating, and finally F the (centrifugal) force parallel to the axis of rotation).

Another embodiment makes use of a mechanical guideway on the drogue so that by rotating (yawing) the drone the arms open up, by having the arms configured such that they enter tracks on the drogue that will expand them enough to open the arms.

A combination of the two above methods can also be used to open the arms and as well combining actuators on the arms with those two methods.

As mentioned above, the docking unit in preferred embodiments comprises a sensor array comprising at least one and preferably at least two sensors and more preferably at least five sensors, that may independently be either active or passive and may include one or more optical lenses. The sensors are preferably electronically connected to a central processor unit (CPU) and associated memory in the UAV or docking unit. In a useful embodiment, the memory comprises software that when executed enables automatic landing and docking of the UAV guided by data from images acquired by said sensor array. The sensor array is comprised of cameras (optical lenses) but also additionally or alternatively any other active or passive type of sensors, for example LiDAR, radar, ultrasound or other. Thus, the sensor array aids the UAV automatically landing and in this regard it is beneficial to have more than one sensors to provide a wider angle of view and preferably combining in the sensor array different types of sensors for increased robustness and some embodiments provide to a certain extent three-dimensional image data of the ground base platform as the UAV is landing.

The sensor array can advantageously also be used for any type of image and other data collection, such as is presently performed with conventional camera equipped UAVs, such as but not limited to aerial photography, geographic surveying, surveillance (e.g., security surveillance, wildlife surveillance, search-and-find rescue operations, etc.) Multiple cameras in the sensor array provide advantages for such image applications, such as by providing a wider angle of view and easier possibilities of obtaining images from other angle than vertical. This also applies with other types of sensors such as LiDAR. In some embodiments the sensor array comprises at least two camera lenses but preferably the sensor array comprises at least three, four or five camera lenses. In one embodiment, the sensor array comprises one lens directed downwardly through the apex of the cone, and at least one lens directed at an angle from vertical, such as e.g. 30° or 45° from vertical (meaning the vertical axis of the UAV and the cone), but preferably at least two lenses at an angle from vertical and even more preferably at least three or four lenses at an angle from vertical such as but not limited to 30°, 45°, 60 or 90° from vertical. These same orientational features may also apply to other types of sensors and any combination of camera sensors and other sensors such as but not limited to LiDAR. Thus in some embodiments the sensor array comprises two, three, four, five or more number of sensors where at least one and optionally two or more sensors are other sensors than optical lenses, such as any of the above mentioned or a combination of those, optionally in combination with one or more optical camera lenses.

In preferred embodiments, image and/or other data collection can be remotely controlled or automatically by the onboard computer or computers. Thus, in some embodiments, this entails switching recording from one sensor to another, zooming, etc. In some embodiments, a part of the cone is rotatable so that the UAV can fly straight in one direction (or stand still) while said lower part is rotated, and with it one or more sensors (e.g. camera lens), to direct the respective sensor(s) in a desired direction. In another embodiment the cone comprises one or more window which is/are larger than the viewing angle of the sensor or sensors behind the window(s), and wherein the sensor or sensors can be slightly rotated or tilted to alter the viewing angle, without the edges of the window(s) blocking the view.

As appears from above, in some embodiments the camera array (sensor array) comprises one or more additional sensors/image detectors, in addition to or alternative to conventional optical lenses, such as but not limited to a thermal image sensor (For example LWIR, SWIR, MWIR or NIR), a multispectral or hyperspectral sensor, as well as camera sensors collecting any wavelength of light as well as active sensors such as LiDAR and RADAR sensors or other similar the actively send out pulses and measure their return.

The docking unit comprises in some embodiments a chargeable battery enclosed in the cone portion. The chargeable battery, whether housed in the docking unit or otherwhere in the UAV, is in a preferred embodiment connected to a charging contact arranged on the surface of the cone, such that the charging contact will come in contact with a mating electric contact in the drogue of the ground base platform, to enable charging of the UAV. Thus, the ground base platform comprises in preferred embodiments a larger battery that allows charging of the battery of the UAV, and/or the ground base platform is connected to the electric grid and includes a power transformer to output an appropriate voltage for charging the battery in the UAV docking unit through the charging contact on the cone.

The docking unit must be securely fastened to the UAV with a rigid or flexible connection. A flexible connection is preferred such as but not limited to using springs and dampeners or rubber to allow the docking unit (the cone) to reduce peak loads upon contact, dampen the movement of the cone or allow it to flex a bit in order to improve the docking.

The system can in some embodiments be used to recharge the battery on the UAV by utilizing regenerative breaking similar as on a windmill to create electricity by having the wind rotate the propellers once the drone is docked. In some embodiments, to increase the efficiency the docking system can be moved or tilted in a way so that the propellers will be more parallel to the wind. This can be arranged by having the ground base platform comprising a mechanism for tilting the drogue receptacle. In one embodiment this is arranged by having the drogue tiltable with a mechanism for tilting in one direction the cone axis of the drogue, and by having the drogue unit rotatable within or on top of a main unit, so that the tilted drogue can face any direction (e.g., a direction facing the wind, at any given moment).

### BRIEF DESCRIPTION OF FIGURES

FIG. 1 shows an embodiment of the ground base platform of the invention.

FIG. 2 shows an embodiment of the docking unit, not connected to a UAV.

FIG. 3 shows the docking unit from FIG. 2 docked and latched to the ground base unit from FIG. 1.

FIG. 4 shows the docking unit of the invention attached to a UAV.

FIG. 5 shows the docking unit approaching a ground base station.

FIG. 6 shows view angles from five lenses of a camera array located in the docking unit.

FIG. 7 shows two windows with respective lenses located behind them and the viewing angles from these lenses.

FIG. 8 illustrates on the left the viewing angle from one downwardly facing lens, and on the right viewing angles from three downwardly facing lenses and the corresponding ground coverage.

### DETAILED DESCRIPTION

In the following, exemplary embodiments of the invention will be described, referring to the figures. These examples are provided to provide further understanding of the invention, without limiting its scope.

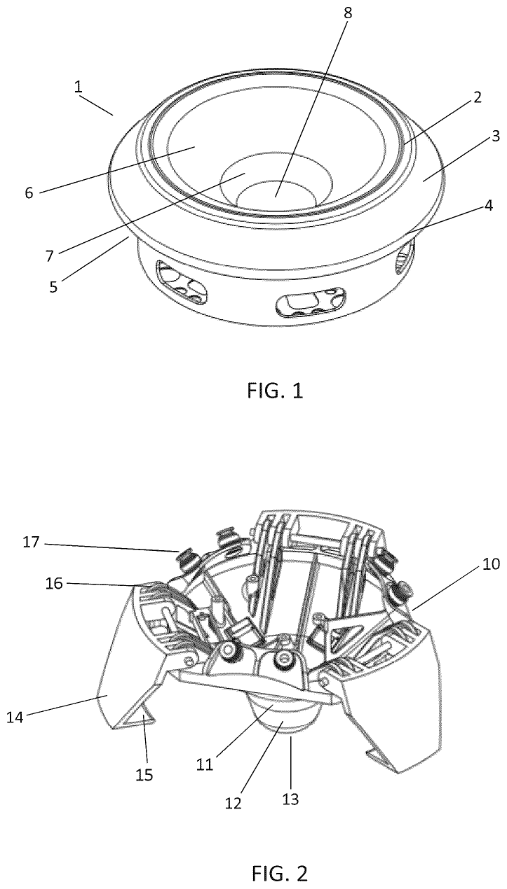

An embodiment of the ground base platform (1) is shown in FIG. 1. The drogue receptacle in this embodiment has two portions with different angle of inclination, a lower portion (7) with a steeper angle and an upper portion (6) with less steep angle of inclination. These angles of inclination match corresponding cone angles of the cone of the docking unit, as seen in FIG. 2. A bottom portion (8) of the drogue accommodates a bottom apex portion (13) of the cone. An upper rim (2) defines an upper edge of the ground base unit. Outside of the upper rim (2) is a tapered collar (3), that tapers down to an edge rim (4) below which is an inwardly extending edge (5) (not shown in FIG. 1).

FIG. 2 shows an embodiment of the docking unit (10), without engaged UAV. The cone of the unit has two main portions (11,12) a lower portion (12) with a steeper angle and an upper portion (11) with a less steep angle, as well as a rounded apex portion (13). These portions match the corresponding portions (6,7,8) of a mating ground base platform as described above. This docking unit is equipped with three clamping arms (14) that each has an inwardly extending foot or hook part (15). The clamping arms are engaged to the docking unit with hinges (16) that are arranged with a spring function (not shown) that pulls their lower parts inwardly towards the cone. Dampening fasteners (17) are placed on the upper part of the docking unit, to engage to a UAV. The dampening fasteners ensure that if the UAV with the engaged docking unit suffers a rough landing, the main impact is taken up by the docking unit whereas the UAV with its delicate propellers etc. is protected from harsh motions and impacts via the dampeners.

Both FIG. 1 and FIG. 2 show how in this embodiment, the cone of the docking unit has two phases or portions, a lower portion (12) with a steeper angle, that mates with a corresponding lower drogue portion (8), and an upper cone portion (11) with a wider angle, that mates with a corresponding upper drogue portion (7).

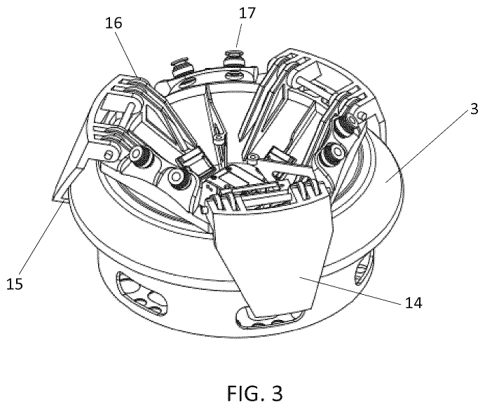

FIG. 3 shows the docking unit (10) engaged with the ground base station (1), showing how the clamping arms (14) latch to the ground base as the foot or hook parts (15) of the clamping arms (14) extend underneath the inwardly extending edge (5) below the tapered collar (3).

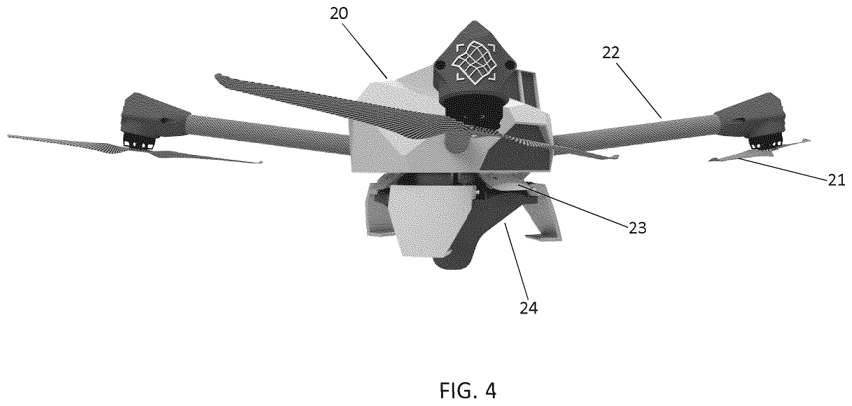

FIG. 4 illustrates an embodiment of the docking station (10) engaged with an UAV (20). The lower portion of the UAV in the depicted configuration comprises flaps (23) that engage through holes (24) with the dampeners (17) on the docking unit. The UAV is equipped with conventional propeller arms (22) and propellers (21).

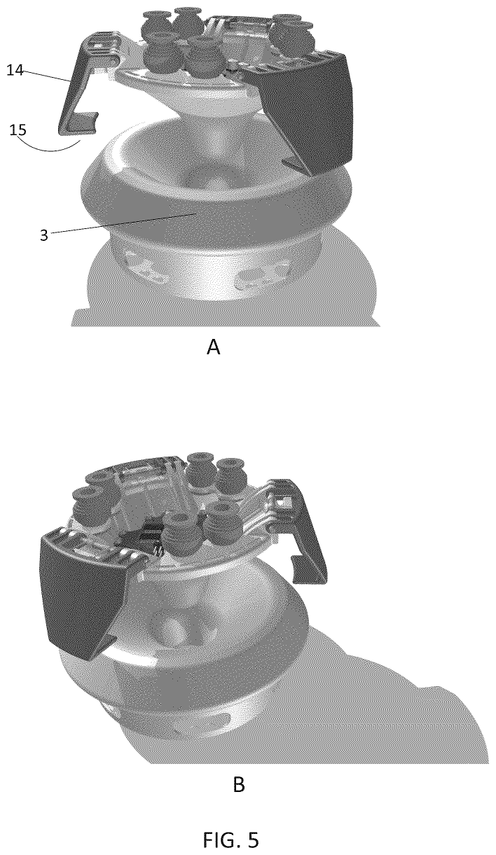

FIG. 5 shows how a docking unit (10) (UAV not shown) approaches the ground base station (1). When the foot or hook parts (15) of the clamping arms (14) touch the tapered collar (3) of the base, they extend outwardly as the docking unit moves downwardly, until the docking unit cone sits firmly in the drogue, then the foot or hook parts (15) latch under the inwardly extending edge (5).

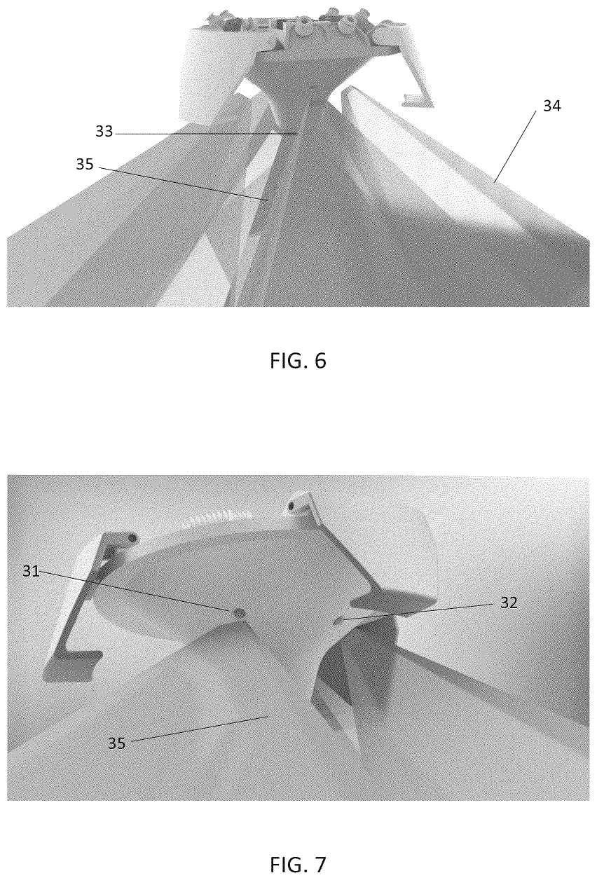

The sensor array with a plurality of lenses and/or other sensors provides a much wider combined view angle. This is illustrated in FIG. 6, which illustrates as solid angles the viewing angles from a total of five optical lenses, one directed downwardly from the apex of the cone and the remaining four lenses distributed around the cone 90° apart. FIG. 7 shows two of the lens widows from another view.

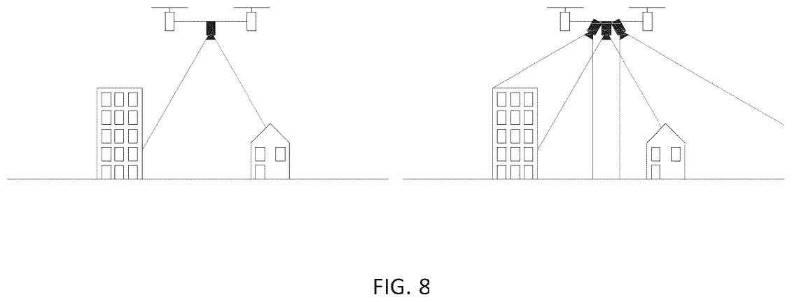

FIG. 8 shows how the sensor array gives more detailed image data that provide a more detailed and accurate surface map. The coverage of vertical structures is greatly improved when using a camera array versus a single nadir camera.

1. A landing and docking system for an unmanned aerial vehicle (UAV) that comprises
a) a ground base platform comprising a drogue receptacle, an upper rim above the receptacle, a tapered collar extending outwardly and downwardly from the upper rim to an inwardly extending edge,
b) a docking unit, configured to be attached to the UAV, the docking unit comprising
a downwardly extending central cone portion shaped to mate with the drogue shaped receptacle of the ground base platform,
at least two and preferably three clamping arms joined to the landing platform above and radially outwardly of the central conical portion, the clamping arms being joined each with a hinge or joint mechanism on the upper part of the clamping arm with a spring function, each clamping arm comprising an inwardly extending foot or hook part, the spring function providing a spring force pulling the foot or hook part of each arm inwardly, said clamping arms configured such that as the docking unit docks with the ground base platform the arms are initially pushed outwardly by the tapered collar of the ground base platform, and as the central conical portion is settled in the drogue receptacle the foot or hook parts slide under the inwardly extending edge so as to hold the docking unit in place in the ground base platform.

2. The landing and docking system according to claim 1, wherein said clamping arms are configured to clamp and lock the UAV to the platform mechanically and automatically when docking.

3. The landing and docking system according to claim 1, comprising an electrically controlled mechanism for unlocking the clamping arms from a locked docking position.

4. The landing and docking system according to claim 1, wherein said docking unit comprises a sensor array comprising at least one sensor and preferably at least two or more sensors that are electronically connected to a central processor unit (CPU) and associated memory in the UAV or docking unit.

5. The landing and docking system according to claim 4, wherein said associated memory comprises software that when executed enables automatic landing and docking of the UAV guided by data from images acquired by said sensor array.

6. The landing and docking system according to claim 4, wherein said sensor array collects image data that is stored in a memory in said UAV or docking unit.

7. The landing and docking system according to claim 6 wherein image and/or data collection can be remotely controlled.

8. The landing and docking system according to claim 4, wherein said docking unit further comprises at least one further image detector selected from a thermal image sensor, including LWIR, SWIR, MWIR and NIR sensor, multispectral sensor, hyperspectral sensor, LiDAR sensor, RADAR sensor or other active sensor.

9. The landing and docking system according to claim 1, wherein said ground base platform comprises a charging unit and electric connection to connect with a mating connector on the docking unit to enable charging a battery within the UAV and/or docking unit.

10. The landing and docking system according to claim 1, wherein said docking unit comprises a chargeable battery enclosed in said cone portion.

11. The landing and docking system according to claim 1, wherein said docking unit comprises a fastening arrangement for securely fastening said UAV to the docking unit, wherein said fastening arrangement comprises suspension members providing suspension between the docking unit and UAV.

12. The landing and docking system according to claim 1, wherein the ground base platform comprises a mechanism for tilting the drogue receptacle, so that a docked UAV can be tilted.

13. A UAV system comprising a UAV and engaged docking unit as defined in claim 1.

14. The UAV system according to claim 13, wherein the UAV is configured so that when docked, kinetic energy from wind-based movement of propellers is harnessed for regenerative charging of the battery in the UAV or docking unit.

15. A kit comprising the landing and docking system according to claim 1, and a UAV that can engage with the docking unit.
